(19) United States
(12) Patent Application Publication
(10) Pub. No.: US 2023/0091292 A1
(43) Pub. Date: Mar. 23, 2023

(54) VALIDATING CROWDSOURCED FIELD REPORTS BASED ON USER CREDIBILITY

(71) Applicant: Chris Shughrue, Canaan, NY (US)

(72) Inventor: Chris Shughrue, Canaan, NY (US)

(21) Appl. No.: 17/462,125

(22) Filed: Aug. 31, 2021

(51) Int. Cl. G06F 16/215; G06F 16/22; G06F 16/23

(52) U.S. Cl. CPC G06F 16/215; G06F 16/2282; G06F 16/23

(57) ABSTRACT

Example systems, devices, media, and methods are described for evaluating the validity of crowdsourced field reports without reference to ground truth data. A field report validation system evaluates user-submitted labels, each representing a place attribute, by applying an iterative model to select the accepted label. The method includes identifying a subset of field reports for an evaluation time period. A set of tentatively accepted labels is generated by the model, iteratively, by submission timestamp. Each tentatively accepted label is based on a user credibility score and a decay factor associated with the relative age of each user-submitted label. The model repeats iteratively, by place attribute and by place identifier, to generate supersets of tentatively accepted labels and to update the user credibility scores. When the values converge, the model identifies an accepted label for each place attribute in the subset. The model evaluates both the validity of field reports and the relative credibility of users without using expert content moderators or ground truth data sets.

### TECHNICAL FIELD

Examples set forth in the present disclosure relate to the field of electronic records and data analysis, including user-provided content. More particularly, but not by way of limitation, the present disclosure describes evaluating crowdsourced field reports based on user credibility.

### BACKGROUND

Maps and map-related applications include data about points of interest. Data about points of interest can be obtained through crowdsourcing.

Crowdsourcing involves a large, relatively open, and evolving pool of users who can participate and gather real-time data without special skills or training. The quality of crowdsourced place data varies widely, depending on the accuracy of the field reports and the credibility of the users.

Users have access to many types of computers and electronic devices today, such as mobile devices (e.g., smartphones, tablets, and laptops) and wearable devices (e.g., smartglasses, digital eyewear), which include a variety of cameras, sensors, wireless transceivers, input systems, and displays.

### BRIEF DESCRIPTION OF THE DRAWINGS

Features of the various examples described will be readily understood from the following detailed description, in which reference is made to the figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 is a flow chart listing the steps in an example method of selecting an accepted label;

FIG. 2A is a diagram illustrating an example subset of field reports, analyzed according to an example time iteration of the model described herein;

FIG. 2B is a diagram illustrating an example list of distinct candidate labels and cumulative scores for the example time iteration shown in FIG. 2A;

FIG. 3A is a diagram illustrating the example subset of field reports of FIG. 2A, analyzed according to another example time iteration;

FIG. 3B is a diagram illustrating an example list of distinct candidate labels and cumulative scores for the example time iteration shown in FIG. 3A;

FIG. 4 is a diagram illustrating a comparison of each user-submitted label with the tentatively accepted label that was selected by applying the model to the example subset of field reports of FIG. 2A;

FIG. 5 is a diagram illustrating example sets of tentatively accepted labels, arranged by place-attribute pair, for evaluating whether a label condition is satisfied;

FIG. 6 is a diagrammatic representation of a machine in the form of a computer system within which a set of instructions may be executed for causing the machine to perform any one or more of the methods or processes described herein, in accordance with some examples; and

FIG. 7 is block diagram showing a software architecture within which the present disclosure may be implemented, in accordance with examples.

### DETAILED DESCRIPTION

Maps and map-related applications frequently include incorrect or stale data about points of interest. Various implementations and details are described with reference to examples for evaluating the validity of user-submitted labels from crowd-sourced field reports, e.g., for updating data about points of interest. For example, a mathematical model generates a set of tentatively accepted labels iteratively, by submission timestamp, for a subset of field reports. Each tentatively accepted label is based on a user credibility score and a decay factor associated with the relative age of each user-submitted label. The model repeats iteratively, by place attribute and by place identifier, to generate supersets of tentatively accepted labels and to update the user credibility scores. When the values converge, the model identifies an accepted label for each place attribute in the subset. The probabilistic model evaluates the validity of user-submitted field reports, and the relative credibility of the users, without using expert moderators or ground truth data sets.

Example methods include identifying a subset of stored field reports according to an evaluation time period and identifying one or more distinct place identifiers in the subset, wherein each identified distinct place identifier is associated with a set of place attributes. The method includes establishing one or more place-attribute pairs, each comprising one of the distinct place identifiers and its associated set of place attributes. Using a mathematical model, the method includes generating a set of tentatively accepted labels, each associated with one of the user-submitted labels and its associated submission timestamp, from a first timestamp to a reference timestamp. Each tentatively accepted label is based on the global user credibility score, a decay factor, and a cumulative candidate label score. The method includes repeating this generating process iteratively, by submission timestamp, until the reference timestamp equals a last timestamp.

In some implementations, the method includes producing a first set of tentatively accepted labels associated with a first distinct place identifier, iteratively, by place attribute, for each place attribute in the associated set of place attributes, and also producing a subsequent set of tentatively accepted labels associated with a subsequent distinct place identifier, iteratively, by place identifier, for each distinct place identifier in the subset. The process further includes determining whether a label condition is satisfied based on a comparison of each set of tentatively accepted labels in the current superset, by place-attribute pair, with each set of tentatively accepted labels in at least one preceding superset. In response to determining that the label condition is satisfied, the method includes selecting an accepted label for each place attribute in the subset, wherein each accepted label comprises a most recent value from the current superset.

In response to determining that the label condition is not satisfied, the method includes updating the global user credibility score associated with each user identifier based on an evaluation of each and every user-submitted label in the subset as of its associated submission timestamp, and repeating the generating process, iteratively and in accordance with the updated global user credibility score, to produce a next superset of tentatively accepted labels associated with a next iteration, until the label condition is satisfied.

Although the various systems and methods are described herein with reference to evaluating the authenticity of place attributes, the technology described may be applied to evaluating the relative authenticity, credibility, or value of any data.

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and method described because the relevant teachings can be applied or practice in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Maps and map-related applications frequently include incorrect or stale data about points of interest. Sending field experts to gather and update place data is time-consuming and expensive. Proprietary datasets are expensive and irregular. The data quality varies geographically, with acceptable data in the largest cities and relatively poor coverage elsewhere. Hiring expert content moderators to review and confirm user-submitted place data adds delay and expense, often defeating the benefits of gathering place data from non-expert users.

In the example context of map-related applications, a user may submit a field report about a new place (e.g., an Add Place action) or about an existing place (e.g., a Suggest Edit action). In some applications, the format of a field report includes place data that is limited to a predefined set of attributes, some of which are expected to be relatively static over time (e.g., name, address, business type, telephone number) while others are subject to change or dynamic (e.g., admission policies, hours of operation, amenities). A field report submitted by a user, for example, includes a data submission or label (e.g., café) associated with a particular attribute (e.g., business type). The field report need not include a label for each and every attribute. For example, a Suggest Edit action may include a single label associated with one attribute. An Add Place action may include labels for most or all the attributes.

For an active application in use, thousands of users are engaged and participating in various ways, including by submitting field reports that contain place data. For applications that allow relatively unlimited submissions, the incoming field reports often include overlapping labels. In one aspect, overlapping labels about a particular attribute tend to confirm the accuracy of the label. For example, hundreds of users might submit the label “Acme Bank” for a “Business Name” attribute associated with a particular place. The receipt of multiple labels in common suggests that the label is accurate. In another aspect, labels can be partially conflicting relative to other field reports (e.g., café versus restaurant, for a “Business Type” attribute) or, in some cases, in total conflict (e.g., bank versus pharmacy).

Occasional conflicts of varying degrees among user-submitted labels are generally expected, due to errors, misspellings, and subjective assessments (e.g., cake shop versus bakery). A significant conflict among incoming field reports, however, suggests there is an important issue with a particular place. The issue might represent a genuine change, such as new operating hours or a new business name. The issue might also indicate suspicious user behavior (e.g., erroneous field reports, fraudulent submissions, malicious intent) or another anomaly that warrants further investigation.

Users and participating business want place data that reflects the objective ground truth; in other words, place data that is accurate, reliable, and up to date. Ground truth place data can be sought by purchasing proprietary third-party datasets or by sending expert investigators into the field. Hiring expert content moderators to investigate and resolve every conflict takes time and adds expense.

The systems and methods described herein, in one aspect, facilitate the resolution of conflicting crowdsourced data without relying on objective ground truth data.

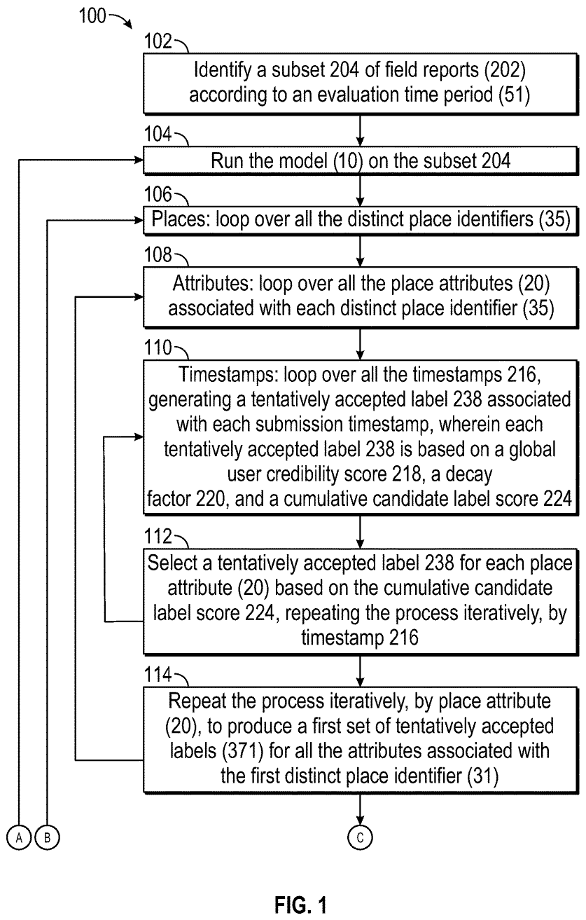

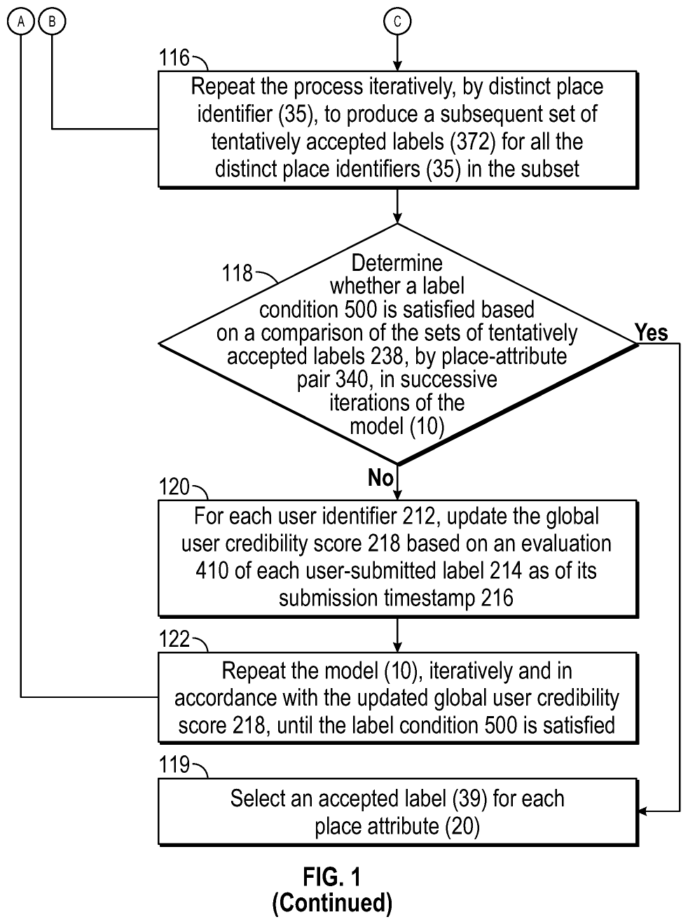

FIG. 1 is a flow chart 100 listing the steps in an example method of selecting an accepted label from among a plurality of generated sets of tentatively accepted labels, in accordance with an example model for evaluating the user-submitted labels in a subset of field reports. The flow chart 100 includes the process of calculating a decay factor 220, which is particularly well suited for place attributes that are dynamic or subject to change over time (e.g., operating hours). For place attributes that remain relatively static over time (e.g., business name), the process does not include calculating a decay factor 220. In this aspect, the static place attribute represents an exceptional case relative to one or more steps described in the flow chart 100.

Although the steps are described with reference to field reports, labels, place attributes, and place data, other beneficial uses and implementations of the steps described will be understood by those of skill in the art based on the description herein. One or more of the steps shown and described may be performed simultaneously, in a series, in an order other than shown and described, or in conjunction with additional steps. Some steps may be omitted or, in some applications, repeated.

In some example implementations, a field report 202 includes a user identifier 212, a submission timestamp 216, a place identifier 35, and at least one user-submitted label 214 representing a place attribute 20. The user identifier 212 in some implementations includes a username, a device identifier (e.g., a device IP address, device metadata), geolocation data associated with a user device (e.g., image metadata in EXIF format), and other indicia associated with a particular person who is a participating or registered user. The submission timestamp 216 in some implementations represents the date and clock time when a field report 202 is submitted by a user. The place identifier 35 in some implementations includes a place name, a unique place number (e.g., a reference or serial number), a geospatial identifier (e.g., geographic metadata, GPS data), and other indicia associated with the geographic place where a field report 202 was submitted.

Field reports 202 may be stored in a memory 604 (e.g., in a field report database or set of relational databases) of one or more computing devices 600, such as those described herein. Similarly, user records may be stored in a memory 604 (e.g., in a user database or set of relational databases) of one or more computing devices 600. A user record in some implementations includes a user identifier 212, a global user credibility score 218, and a variety of other user-specific data and information.

A user-submitted label 214 in some implementations includes one or more characters (e.g., letters, words, digits, blank spaces, punctuation), a value (e.g., a selection from a menu, a value associated with a particular variable), or any other indicia associated with or representing a place attribute 20. A place attribute 20 in some implementations includes any of a variety of attributes associated with a place or point of interest, including attributes that are expected to remain relatively static over time (e.g., name, address, business type, telephone number) and other attributes that are relatively dynamic, variable, or subject to change over time (e.g., admission policies, hours of operation, amenities). For example, a user-submitted label 214 that includes the text string “Acme Bank” may be submitted to represent the place attribute 20 entitled “Business Name.” Another example user-submitted label 214 that includes the numerical value 8 may be submitted to represent the place attribute 20 entitled “Open Hours on Mondays.”

Block 102 in FIG. 1 describes an example step of identifying a subset 204 of a plurality of field reports 202 according to an evaluation time period 51. The field reports 202 may be stored in a memory, as described herein. In this aspect, the example step of identifying a subset 204 includes retrieving a subset 204 of the stored field reports 202 from memory. The subset 204 in some implementations may be identified by parsing the data contained in the field reports 202, by submission timestamp 216, according to a desired or particular evaluation time period 51 (e.g., from a starting date and time to an ending date and time). In some implementations, the evaluation time period 51 may span the timestamps associated with most or all the field reports 202.

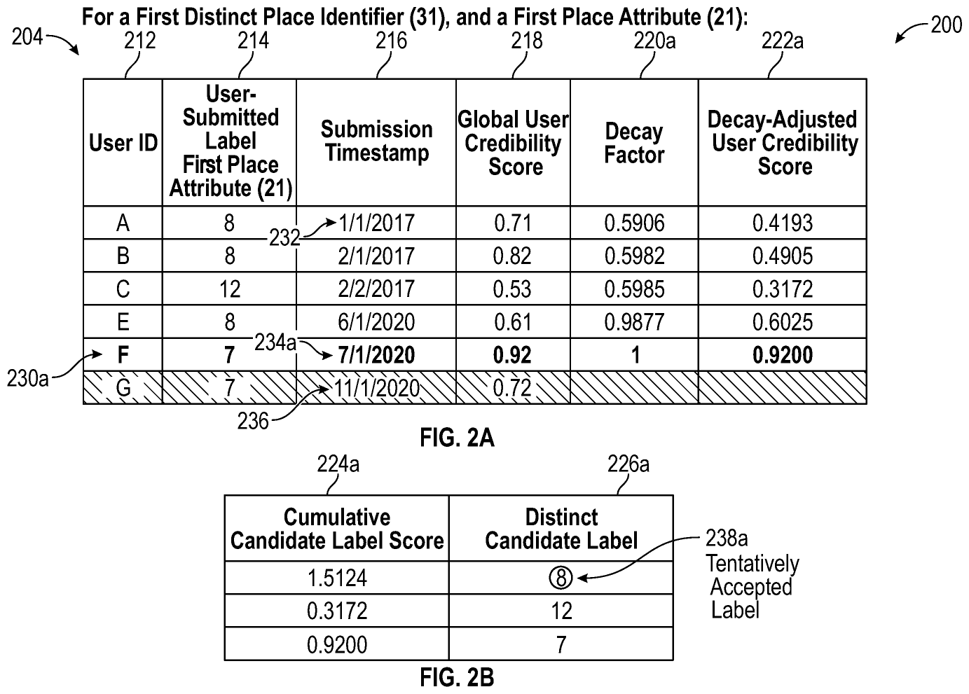

The example subset 204 of field reports 202 shown in FIG. 2A is relatively small, to provide a simple example. In practice, however, a subset 204 for analysis may include a large number of field reports. Moreover, the example step at block 102 of identifying a subset 204, in some implementations, includes retrieving one or more additional subsets, each including field reports 202 from a different evaluation time period. For example, a subset 204 of field reports for a first selected place identifier 31 and a first selected place attribute 21 may span a relatively long duration (e.g., ninety days). The subset 204, in some implementations, may be divided or parsed into one or more additional subsets, according to different evaluation time periods (e.g., the earliest ten days in the period, the forty days ending with the most recent field report).

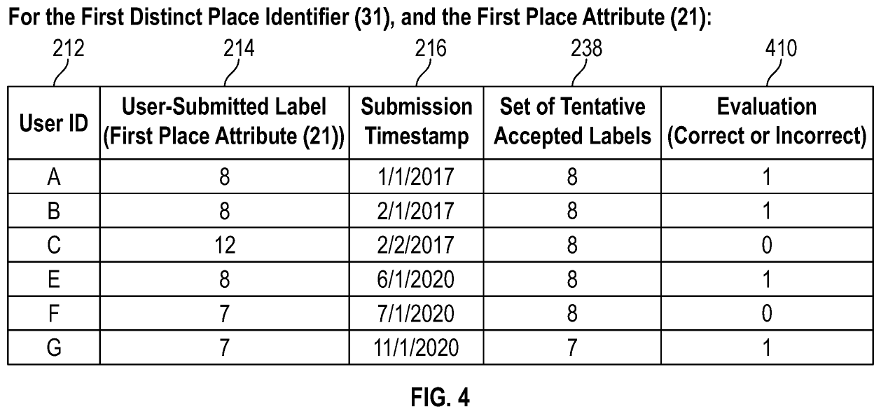

In another aspect, example step of identifying a subset 204 of a plurality of field reports 202 according to an evaluation time period 51 includes one or more initialization steps. For example, in some implementations, a first iteration includes setting the global user credibility score 218 for each user identifier 212 to 0.5, where a value of one would indicate perfect credibility (i.e., user-submitted labels 214 always correct) and a value of zero would indicate their user-submitted labels 214 are always incorrect. In a related aspect, for a second and subsequent iterations, the initialization steps, in some implementations, include using the updated global user credibility score 218 for each user identifier 212 for the next iteration of the model 10 described herein. The initialization steps, in some implementations, include establishing a null or empty set for the set of tentatively accepted labels 238 (e.g., the set 238 shown in FIG. 4 would be initialized as an empty set).

Block 104 in FIG. 1 describes an example step of running a mathematical model 10, as described herein, on the identified subset 204 of field reports. In some implementations, as shown, the model 10 is repeated iteratively until a label condition 500 is satisfied (Block 122).

Block 106 in FIG. 1 describes an example step of looping over all the distinct place identifiers 35 in the subset 204. In some implementations this example step includes a process of identifying one or more distinct place identifiers 35 in the subset 204. As used herein, the distinct values in a set or subset include all the different values in the set, with duplicates removed so that only one instance of each distinct value is included. In practice, the subset 204 may include a large number and a wide variety of place identifiers 330 among the many field reports 202 in the subset. For example, the subset 204 may include three hundred instances a place identifier 330 (e.g., AB31NK6) associated with the place known as Acme Bank. After removing the duplicate instances, the list of distinct place identifiers 35 would include a single instance of AB31NK6. In some implementations, as shown, the process of looping over all the distinct place identifiers 35 in the subset 204 is repeated iteratively, by place identifier, until all the model 10 has been applied to all the distinct place identifiers 35 (Block 116).

Each of the identified distinct place identifiers 35 is associated with a set of place attributes 20. For example, the place known as Acme Bank may include a large number and a wide variety of place attributes 20 (e.g., a place identifier 330 (AB31NK6), address, business type, telephone number, hours of operation, admission policies, and the like). The place attributes 20 associated with a particular place identifier may be referred to herein as a set 25 of place attributes. Block 108 in FIG. 1 describes an example step of looping over all the place attributes in the set 25. In some implementations, as shown, the process of looping over all the place attributes is repeated iteratively, by place attribute 20, until all the model 10 has been applied to all the place attributes in the set 25 (Block 114).

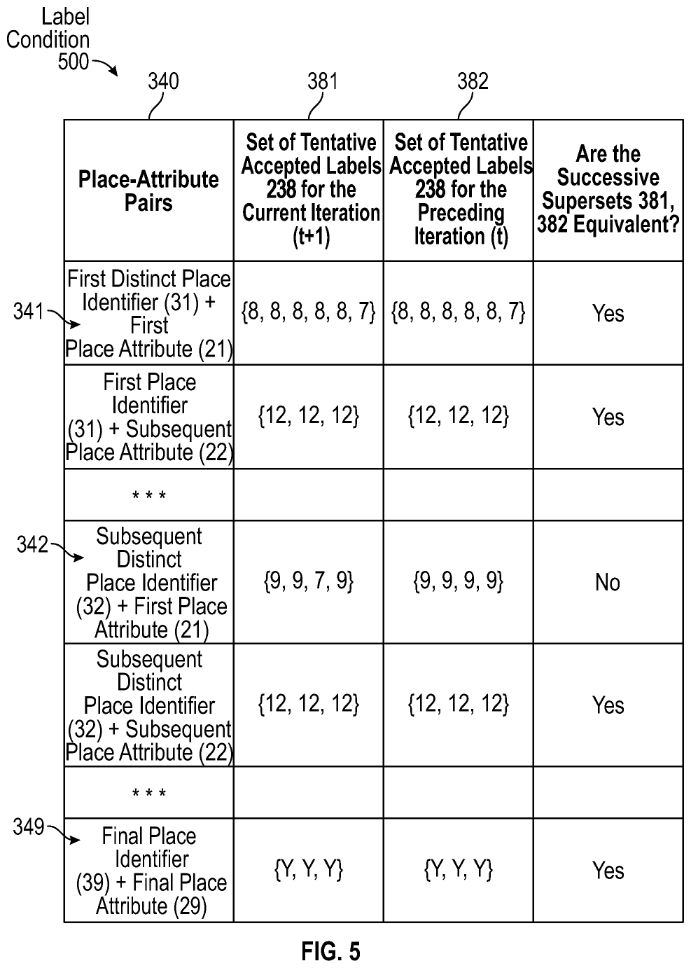

In a related aspect, the step of identifying and looping over place identifiers and attributes, in some implementations, includes establishing one or more place-attribute pairs 340 (FIG. 5), each comprising one of the distinct place identifiers 35 and its associated set 25 of place attributes.

Block 110 in FIG. 1 describes an example step of looping over all the submission timestamps 216 associated with each user-submitted label 214 in the subset 204. In some implementations, as shown, the process of looping over all the submission timestamps 216 is repeated iteratively, by timestamp, until all the model 10 has been applied to all the submission timestamps 216 in the subset 204 (block 112).

In another aspect, an example step of looping over all the submission timestamps 216 includes generating a set of tentatively accepted labels 238, each one associated with one of the user-submitted labels 214 and its associated submission timestamp 216. In some implementations, the group of submission timestamps 216 spans the time from a first timestamp 232 to a reference timestamp 234. As described herein, in some implementations, each tentatively accepted label 238 is based on a global user credibility score 218, a decay factor 220, and a cumulative candidate label score 224.

FIG. 2A is a diagram illustrating an example subset 204 of field reports, analyzed according to an example iteration of the model 10 described herein. The model 10, in some implementations, is part of a field report validation system 200. The subset 204, in this example, includes field reports that are associated with a first distinct place identifier 31 (from among the identified list of distinct place identifiers 35). As shown, the example subset 204 includes a record (e.g., each row, in this example) associated with each of several user identifiers 212 which are denoted using the letters A, B, C, E, F, and G. For clarity, the subset 204 in this example includes only six records. A typical subset 204 for analysis and study by the model 10 described herein may include hundreds or thousands of records.

The next column shows an example a user-submitted label 214 for a first place attribute 21 (e.g., Open Hours on Mondays) associated with the first distinct place identifier 31 (e.g., Acme Bank). As shown, the user-submitted labels 214 in this example include digits indicating the number of hours the bank is open on Mondays. The example submission timestamps 216 indicate the date and time when each field report 202 was submitted. The timestamps 216 in some implementations include the date and a universal or coordinated clock time.

In the example shown, the user-submitted labels 214 are disparate, ranging in value from seven to twelve. The disparate values reveal a conflict among the incoming field reports 202, suggesting there might be a potential issue with this particular place attribute 21 or place identifier 31. The potential issue might represent a genuine change (e.g., new operating hours), a reporting error (e.g., a user entering an incorrect value), or some other anomaly in the data. In some implementations, the model 10 described herein is configured to analyze subsets 204 that contain disparate or conflicting user-submitted labels 214 (e.g., rejecting subsets 204 unless the quantity or percentage of disparate labels 214 exceeds a predetermined minimum threshold). In this aspect, for example, a subset 204 that contains similar or homogenous user-submitted labels 214 (e.g., all eights) would not require analysis and resolution by the model 10. Based on the corroboration among this subset of user-submitted labels 214 (e.g., all eights) the model 10 infers that all the users submitted a correct response and, accordingly, each global user credibility score 218 would improve.

The next column shows an example global user credibility score 218 associated with each user identifier 212. The score 218 is described as global because, in some implementations, the global user credibility score 218 reflects the probability that a user-submitted label 214 about a place attribute 20 is correct, based on all the field reports 202 submitted by that user (i.e., for most or all place attributes 20, place identifiers 330, and time periods, as received or stored in the field report database 400). In some implementations, the global user credibility score 218 associated with each user identifier 212 is retrieved from the store user records.

Referring again to block 110 in FIG. 1, in this example implementation, each tentatively accepted label 238 is based on the retrieved global user credibility score 218, a decay factor 220, and a cumulative candidate label score 224. The process for identifying a tentatively accepted label 238, in some implementations, is illustrated in FIG. 2A. As shown, the model 10 is applied to the group of user-submitted labels 214—in this example time iteration—beginning with a first timestamp 232 and ending with a reference timestamp 234a (i.e., the labels 214 associated with the user identifiers 212 labeled A, B, C, E, and F). In some implementations, the first timestamp 232 is the earliest time in the subset 204, the last timestamp 236 is the most recent time in the subset 204, and the reference timestamp 234 is a variable associated with the last record under analysis during each successive iteration of the model 10. For example, for a first time iteration, the reference timestamp 234 may be the same as the first timestamp 232 (e.g., spanning the labels 214 associated with user identifier 212 labeled A (only), which of course would represent a trivial set). For a second time iteration, the reference timestamp 234 would increment to the next record (e.g., the user identifier 212 labeled B), so that the group of user-submitted labels 214 under analysis would span from the first timestamp 232 (e.g., user A) and ending with the reference timestamp (e.g., user B). The iteration through the timestamps 216, in some implementations, continues until the reference timestamp 234 equals the last timestamp 236 in the subset 204.

FIG. 2A illustrates the calculation of a decay-adjusted user credibility score 222a associated with each user-submitted label 214 in the subset 204. As shown, the reference timestamp 234a—for this time iteration—is associated with a reference field report 230a (e.g., the user identifier 212 labeled F).

The decay factor 220 represents the relative age of each field report 202 relative to the reference field report 230a. The decay factor 220 is particularly useful when evaluating a series of user-submitted labels 214 submitted over time—and for evaluating a selected place attribute 21, such as “Open Hours on Mondays,” which is likely to undergo an authentic and legitimate change over time (e.g., operating hours that change on a seasonal basis). The example subset 204 shown in FIG. 2A represents a time-based series of user-submitted labels 214 for a first distinct place identifier 31 and a first place attribute 21. The decay factor 220 as described herein is useful in estimating the probability that a user-submitted label 214 is both accurate and current.

The decay factor 220 in some implementations is calculated using an exponential function of the form e^{x}—also written as exp(x)—where the exponent, x, equals the relative age of each timestamp 216 relative to the reference timestamp 234a divided by a parameter (Tau). In one example, the decay factor 220 is calculated according to this equation:

$$d = exp ( \frac{A}{Tau} )$$

where d is the decay factor 220, A is the relative age of each timestamp 216, and Tau is a value associated with a parameter such as the current place attribute (e.g., in this example, the first place attribute 21). For example, this parameter in some implementations is a value associated with the likelihood that a retail business remains open, over time, may be based on the published data surrounding the typical lifespan of retail storefronts of a particular type or in a particular region.

According to the example shown in FIG. 2A, the decay factor 220a associated with the user identifier 212 labeled F equals 1 because the submission timestamp for user F is set as the reference timestamp 234a in this iteration. The decay factor 220a associated with the user identifier 212 labeled A equals 0.5906. The relative age of the first timestamp 232 relative to the reference timestamp 234 is 1,277 days. The parameter in this example is negative 2425. In this example, the exponent (x) is the age (1,277 days) divided by the parameter (−2425) which equals negative 0.5266. The function exp(x) equals 0.5906.

The process of calculating a decay factor 220 as described herein is particularly well suited for place attributes that are subject to change over time (e.g., operating hours, admission policies, occupancy limits, amenities, accessibility, and the like). For place attributes that are expected to remain relatively static over time (e.g., business name, address, business type, telephone number), the process of generating a tentatively acceptable label 238 (described at block 110 in FIG. 1), in some implementations, does not include the decay factor 220. In this example implementation, each tentatively accepted label 238 is based on the retrieved global user credibility score 218 only; followed by the cumulative candidate label scores 224 (without calculating a decay-adjusted user credibility score 222a). For this implementation, the data associated with the format of the place attributes 20 includes a value identifying certain place attributes 20 as static.

The calculation of a decay-adjusted user credibility score 222a in some implementations equals the global user credibility score 218 times the decay factor 220a for each user-submitted label 214 in the subset 204. For the user identifier 212 labeled A, the global user credibility score 218 (0.71) times the decay factor 220a (0.5906) equals the decay-adjusted user credibility score 222a (0.4193).

The next step in identifying a tentatively accepted label 238a for this time iteration is illustrated in FIG. 2B. The next step, in some implementations, includes identifying one or more distinct candidate labels 226a (associated with the current time iteration) from among the user-submitted labels 214 in the subset 204. As used herein, the distinct values in a set include all the different values in the set, with duplicates removed so that only one instance of each distinct value is included. For example, the set of user-submitted labels 214 in FIG. 2A, for this time iteration, includes three instances of 8, one instance of 12, and one instance of 7. Note; the final instance of 7 is not included in this time iteration. After removing the duplicate instances, the list of distinct candidate labels 226a includes 8, 12, and 7, as shown in FIG. 2B.

Another step, in some implementations, includes calculating a cumulative candidate label score 224a associated with each of the identified distinct candidate labels 226a. In some implementations, as shown in FIG. 2B, the decay-adjusted user credibility scores 222a associated with each distinct candidate label 226a are added together to calculate the cumulative candidate label scores 224a. For example, for the distinct candidate label 226a equal to 8, the decay-adjusted user credibility scores 222a associated with records A, B and E (i.e., the user-submitted labels 214 that are equal to 8) are added together to calculate the cumulative candidate label score 224a (1.5124).

For the distinct candidate label 226a equal to 12, the cumulative candidate label score 224a equals 0.3172 (which is the decay-adjusted user credibility scores 222a for the single instance of a user-submitted label 214 equal to 12). Finally, for the distinct candidate label 226a equal to 7, the cumulative candidate label score 224a equals 0.9200 (which is the decay-adjusted user credibility scores 222a for the single instance of a user-submitted label 214 equal to 7).

The step of identifying a tentatively accepted label 238a is based on the calculated cumulative candidate label scores 224a. As shown in FIG. 2B, the distinct candidate label 226a equal to 8 has the highest cumulative candidate label score 224a (1.5124 is greater than the other scores 224a). Accordingly, the tentatively accepted label 238a for this time iteration is 8. Thus, the value of 8 is added to a set of tentatively accepted labels 238, as generated by applying the model 10 to this subset 204.

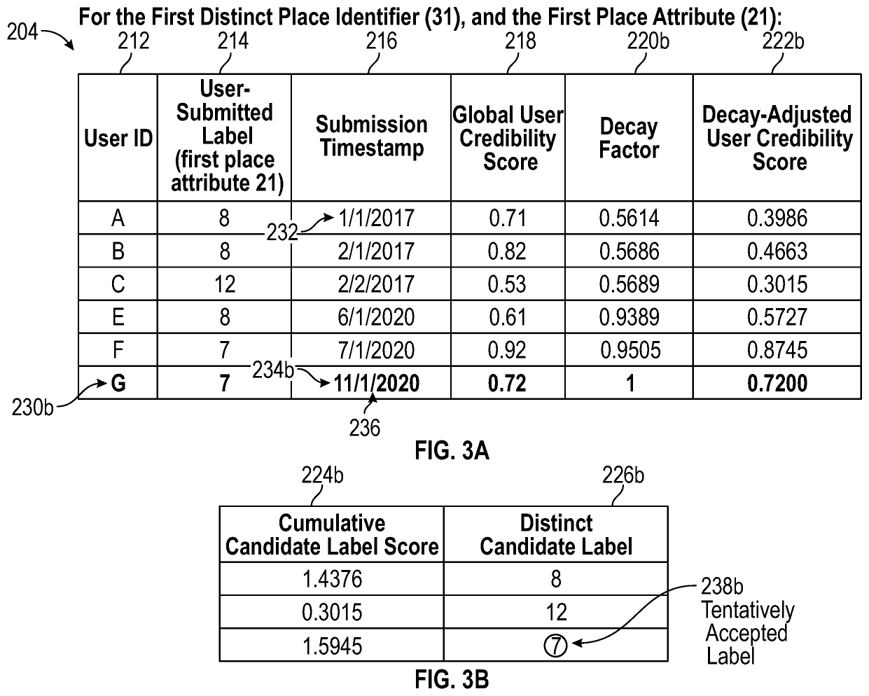

FIG. 3A is a diagram illustrating the example subset of field reports of FIG. 2A, analyzed according to another example time iteration. As shown, the model 10 is applied to the group of user-submitted labels 214—in this example time iteration—beginning with a first timestamp 232 and ending with a reference timestamp 234b (i.e., the labels 214 associated with the user identifiers 212 labeled A, B, C, E, F, and G). In some implementations, the example in FIG. 3A represents the final iteration through the timestamps 216, in which the reference timestamp 234b equals the last timestamp 236 in the subset 204. In other words, this example in FIG. 3A and FIG. 3B represents the final iteration in the process of looping over all the submission timestamps 216 (as shown for block 112 in FIG. 1).

In one aspect of the model 10, the calculated decay factors 220b for each user-submitted label 214 are different in this time iteration, in FIG. 3A, compared to the factors 220a calculated for the previous iteration, shown in FIG. 2A. The decay factors 220b are different because the reference timestamp 234b is now associated with the final reference field report 230b (e.g., the user identifier 212 labeled G). Accordingly, the decay-adjusted user credibility scores 222b are different also.

The next step in identifying a tentatively accepted label 238b for this time iteration is illustrated in FIG. 3B. The next step, in some implementations, includes identifying one or more distinct candidate labels 226b. The set of user-submitted labels 214 in FIG. 3A, for this time iteration, includes three instances of 8, one instance of 12, and two instances of 7. After removing the duplicate instances, the list of distinct candidate labels 226a includes 8, 12, and 7, as shown in FIG. 3B. The cumulative candidate label scores 224b are calculated by adding together the decay-adjusted user credibility scores 222b associated with each distinct candidate label 226a. In this example, the distinct candidate label 226b equal to 7, the decay-adjusted user credibility scores 222b associated with records F and G (i.e., the user-submitted labels 214 that are equal to 7) are added together to calculate the cumulative candidate label score 224b (1.5945).

The step of identifying a tentatively accepted label 238b is based on the calculated cumulative candidate label scores 224b. As shown in FIG. 3B, the distinct candidate label 226b equal to 7 has the highest cumulative candidate label score 224b (1.5945 is greater than the other scores 224b). Accordingly, the tentatively accepted label 238b for this time iteration is 7. Thus, the value of 7 is added to a set of tentatively accepted labels 238, as generated by applying the model 10 to this subset 204.

FIG. 4 is a diagram illustrating a comparison of each user-submitted label 214 with the tentatively accepted label 238 that was selected by applying the model 10 to the example subset 204 of field reports shown in FIG. 2A. For example, for the user identifier 212 labeled B, the user-submitted label 214 was 8 and the tentatively accepted label 238 selected by the model 10 was 8, indicating that user B submitted an accurate and authentic label 214 as of its submission timestamp 216 (which was 2/1/2017). The identified match for user B is expressed, as shown, as an evaluation 410 (e.g., one if correct; zero if incorrect). Each evaluation 410 is based on a comparison of the user-submitted label 214 to the tentatively accepted label 238. For example, for the user identifier 212 labeled C, the user-submitted label 214 is 12 and the corresponding tentatively accepted label 238 was 8, indicated the label was inaccurate and a non-match, resulting in an evaluation 410 of zero (incorrect) for user C.

FIG. 4 illustrates the set of tentatively accepted labels 238—in this example, {8, 8, 8, 8, 8, 7}—for the first place attribute 21 associated with the first distinct place identifier 31. Each iteration through the attributes and places produces a set of tentatively accepted labels 238.

Referring again to FIG. 1, block 114 in FIG. 1 describes an example step of repeating the generating process iteratively, by place attribute 20, to produce a first set of tentatively accepted labels 371 (e.g., for a subsequent place attribute 22, et seq., through and including a final place attribute 29) in the set 25 of place attributes associated with the first distinct place identifier 31. In some implementations, the first set 371 includes all the tentatively accepted labels associated with the first distinct place identifier 31.

Similarly, the process at block 116 describes the example step of repeating the generating process iteratively, by distinct place identifier 35, to produce a subsequent set of tentatively accepted labels 372 (e.g., for a subsequent distinct place identifier 32, et seq., through and including a final distinct place identifier 39); in other words, for all the distinct place identifiers 35 in the subset 204. In some implementations, the subsequent set 372 includes all the tentatively accepted labels associated with each and every distinct place identifier 35 in the subset 204.

Each iteration through all the attributes and places, as described at block 114 and block 116, generates a superset of tentatively accepted labels 381 comprising the first set 371 and the subsequent set 372. In some implementations, the superset 381 for each successive iteration is stored by place-attribute pair 340, as illustrated in FIG. 5.

Block 118 in FIG. 1 describes an example step of determining whether a label condition 500 is satisfied. The label condition 500 in some implementations is based on a comparison of each set of tentatively accepted labels 238 in the current superset 381, by place-attribute pair 340 (e.g., from a first place-attribute pair 341 through and including a final place-attribute pair 349), with each set of tentatively accepted labels 238 in at least one preceding superset 382. FIG. 5 illustrates a current superset 381 associated with a current iteration (labeled t+1) and a preceding superset 382 associated with a preceding iteration (labeled t).

As shown in FIG. 5, each superset 381, 382 may include a different type and number of tentatively accepted labels 238, based on the place-attribute pair 340. For example, the first place-attribute pair 341 includes the tentatively accepted labels 238—in this example, {8, 8, 8, 8, 8, 7}—for the first place attribute 21 (e.g., Monday Hours) and the first distinct place identifier 31, as shown and described in FIG. 2A through FIG. 4. For the first place-attribute pair 341, the successive supersets 381, 382 are equivalent. The label condition 500, however, is not satisfied because the successive supersets 381, 382 for the second or subsequent place-attribute pair 342 are not equivalent. In some implementations, the label condition 500 is not satisfied unless all the successive supersets 381, 382 are equivalent. In use, where there might be hundreds or thousands of place-attribute pairs 340 in a subset 204, a difference identified between any accepted label value in the successive supersets 381, 382 will result in a label condition 500 that is not satisfied.

According to the model 10 described herein, in some implementations, the accepted label values in the successive supersets 381, 382 tend to converge and become equivalent, satisfying the label condition 500. In special cases, which should be unusual, the accepted label values in the successive supersets 381, 382 do not converge; instead, one or more of the accepted label values alternates indefinitely, between iterations (e.g., 8, 7, 8, 7, 8, 7, . . . ). For this atypical edge case, the process of determining whether the label condition 500 is satisfied includes applying a convergence threshold. Instead of required precise equivalence, the label condition 500 would be satisfied if the differences between the accepted label values in the successive supersets 381, 382 are lower than the convergence threshold (e.g., fewer than 0.1% of the accepted label values are different in the successive supersets 381, 382). In this aspect, the convergence threshold allows the label condition 500 to be satisfied for such atypical edge cases.

When the label condition 500 is satisfied, block 119 in FIG. 1 describes an example step of selecting an accepted label 39 for each place attribute 20 in the subset 204 based on the successive supersets 381, 382. The accepted label 39, in some implementations, is the most recent value from each generated set of tentatively accepted labels 238. For example, for the first place-attribute pair 341, the accepted label 39 is 7 because it is the most current value in the set {8, 8, 8, 8, 8, 7}. The selection of 7 as the accepted label 39 for the first place-attribute pair 341 indicates that the first place attribute 21 (Monday Hours) has accurately and authentically changed from 8 hours to 7 hours in duration, based on the user credibility scores 218 and the analysis by the iterative model 10 described herein. In this aspect, the selection of 7 as the accepted label 39 has occurred without reference to ground truth data (e.g., a third-party dataset) and without involving a content moderator or other expert.

When the label condition 500 is not satisfied, block 120 in FIG. 1 describes an example step of updating the global user credibility score 218 associated with each user identifier 212 based on the evaluations 410 of each user-submitted label 214. The evaluations 410 are described and illustrated with reference to FIG. 4. In one aspect, each evaluation 410 is made as of the submission timestamp 216 associated with each user-submitted label 214. In other words, the correctness of the label 214 is judged as of the data available at the time it was submitted. For example, as shown in FIG. 4, several of the user-submitted labels 214 equal to 8 were evaluated as correct, even though the latest or most recent tentatively accepted label 238 is 7.

The process of updating the global user credibility score 218 in some implementations includes calculating the sum of all the evaluations 410 (e.g., one for correct labels, zero for incorrect) associated with each user identifier 212 and dividing that sum by the total number of user-submitted label 214 submitted by that user identifier 212. The sum in some implementations includes the evaluations 410 associated with all the place attributes, by submission timestamp, for all the distinct place identifiers 35 in the subset 204. In this aspect, the sum of the evaluations 410 represents a user credibility related to all of the user-submitted labels 214 in the subset 204.

Block 122 in FIG. 1 describes an example step of repeating the model 10, iteratively and in accordance with the updated global user credibility score 218, until the label condition 500 is satisfied. The process of repeating the model 10, iteratively, produces a next superset of tentatively accepted labels, for comparison at block 118 with the superset generated in the preceding iteration.

The flow chart 100 listing the steps in an example method, shown in FIG. 1, may be expressed in pseudocode, as shown in Table 1 below:

```
TABLE 1
WHILE (ANY (L_{p,a}^{t} ! = L_{p,a}^{t+1})) {
# Run the model 10 until every tentative accepted label (L) in the current iteration (t + 1) is equivalent
to the labels (L) in the preceding iteration (t)
  FOR (p in P) {
  # Loop over places (P); all distinct place identifiers 35
    FOR (a in A) {
    # Loop over all place attributes (A); all place attributes 20 associated with each
    distinct place identifier 35
      FOR (m in M) {
      # Loop over all timestamps (M); all the timestamps 216 associated with each
      field report 202; calculating a decay factor 220 (d) relative to a reference
      timestamp 234a (m) (for dynamic place attributes only, as described herein);
      and identifying a tentatively-accepted label 238 (L) for each place (p),
      attribute (a), and submission timestamp (m), as follows:
      ${d}_{M ( V )} = exp ( \frac{M ( V ) - m}{τ} )$
      ${L}_{p , a , m}^{t} = arg {max}_{v} {\sum }_{u = 1}^{υ} {w}_{u , a} {V}_{u , v} {d}_{M ( V )}$
      } # Iterate to next timestamp 216 (m)
    } # Iterate to next place attribute 20 (a)
  } # Iterate to next distinct place identifier 35 (p)
# Determine whether the label condition 500 is satisfied.
# If yes, select an accepted label 39 for each attribute 20.
# If not, update the global user credibility score 218 (w) for each user (u)
${w}_{u , a} = \frac{\sum {L}_{p , a , m}^{t} == {V}_{u , v , m}}{{N}_{u , a}}$
# next iteration (t)
}
ENDWHILE
```

As described herein, the decay factor 220 (d) is calculated using an exponential function of the form e^{x}—also written as exp(x)—where the exponent, x, equals the relative age (A) of each timestamp 216 divided by a parameter (Tau), according to this equation:

$$d = exp ( \frac{A}{Tau} )$$

In Table 1, the relative age (A) is expressed as “M(V) minus m” or the difference between the submission time 216 (M) for the user-submitted label 214 (V) minus the reference timestamp 234 (m).

For place attributes that are expected to remain relatively static over time (e.g., business name, address, business type, telephone number), the process in some implementations does not include calculating a decay factor 220. In this example implementation, when a place attribute 20 is identified as static, each tentatively accepted label 238 (L) is generated without regard to a delay factor 220 (d). In Table 1, above, the process “FOR (a in A)” (i.e., loop over all place attributes (a)), in some implementations includes looping over the static attributes first; then looping over the other, non-static or dynamic attributes. In this aspect, the iterative process, by timestamp, is applied to both the static and non-static attributes.

The equation below from Table 1 expresses in mathematic form the process of selecting a tentatively accepted label 238 (L) for each distinct place identifier 35 (p), each place attribute 20 (a), and each submission timestamp 216 (m), where the superscript indicates iteration (t).

$${L}_{p , a , m}^{t} = arg \text{?} {w}_{u , a} \text{?} {d}_{M ( V )}$$

$$\text{?} \text{indicates text missing or illegible when filed}$$

The variable “w” stands for the global user credibility score 218. Referring again to FIG. 2A, the global user credibility score 218 (w) times the decay factor 220a (d) equals the decay-adjusted user credibility score 222a. The variable “V” represents the evaluation 410 (FIG. 4). The operation “arg max” together with the summation of user identifiers (u=1 through U) expresses in mathematic form the process (illustrated in FIG. 2B) of selecting a tentatively accepted label 238 (L) based on the maximum of the cumulative candidate label scores 224a.

The final equation from Table 1 expresses the process of updating the global user credibility score 218 (w) by calculating the sum of all the user-submitted labels 214 that matched the tentatively accepted label 238 (L), and then dividing that sum by the total number (N) of labels 214 submitted by that user identifier 212.

$${w}_{u , a} = \frac{\sum {L}_{p , a , m}^{t} == {V}_{u , v , m}}{{N}_{u , a}}$$

The double equal sign is a comparison operator between the summation of labels (L) and the evaluations 410 (V); returning one where L and V are equal and zero otherwise.

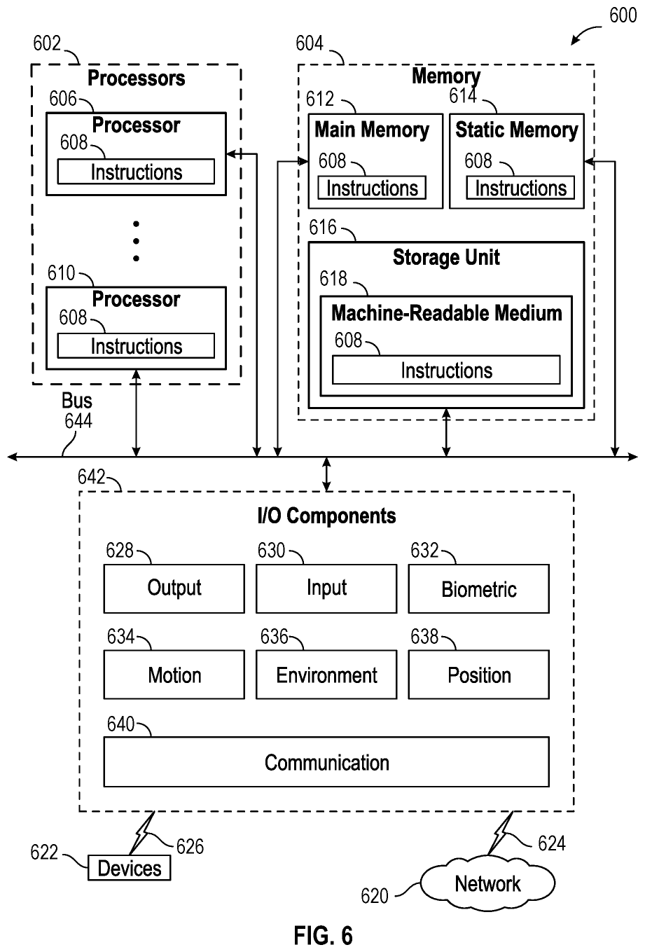

FIG. 6 is a diagrammatic representation of the machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and input/output (I/O) components 642, which may be configured to communicate with each other via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although multiple processors 602 are shown, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 (e.g., a non-transitory machine-readable storage medium) within the storage unit 616, within at least one of the processors 602 (e.g., within the processor's cache memory), or any suitable combination thereof, during execution thereof by the machine 600.

Furthermore, the machine-readable medium 618 is non-transitory (in other words, not having any transitory signals) in that it does not embody a propagating signal. However, labeling the machine-readable medium 618 “non-transitory” should not be construed to mean that the medium is incapable of movement; the medium should be considered as being transportable from one physical location to another. Additionally, since the machine-readable medium 618 is tangible, the medium may be a machine-readable device.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, a resistance feedback mechanism), other signal generators, and so forth. The input components 630 may include alphanumeric input components (e.g., a keyboard, a touch screen configured to receive alphanumeric input, a photo-optical keyboard, or other alphanumeric input components), pointing-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near-field Communication (NFC) components, Bluetooth® components (e.g., Bluetooth® Low Energy), WiFi® components, and other communication components to provide communication via other modalities. The devices 922 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, memory of the processors 602), storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed examples.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

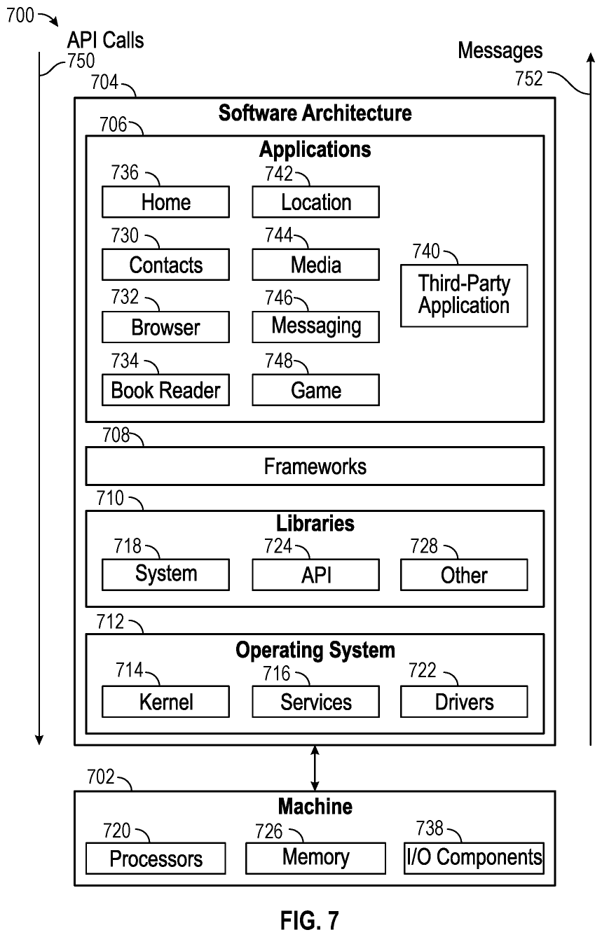

FIG. 7 is a block diagram 700 illustrating a software architecture 704, which can be installed on any one or more of the devices described herein. The software architecture 704 is supported by hardware such as a machine 702 that includes processors 720, memory 726, and I/O components 738. In this example, the software architecture 704 can be conceptualized as a stack of layers, where each layer provides a particular functionality. The software architecture 704 includes layers such as an operating system 712, libraries 710, frameworks 708, and applications 706. Operationally, the applications 706 invoke API calls 750 through the software stack and receive messages 752 in response to the API calls 750.

The operating system 712 manages hardware resources and provides common services. The operating system 712 includes, for example, a kernel 714, services 716, and drivers 722. The kernel 714 acts as an abstraction layer between the hardware and the other software layers. For example, the kernel 714 provides memory management, processor management (e.g., scheduling), component management, networking, and security settings, among other functionality. The services 716 can provide other common services for the other software layers. The drivers 722 are responsible for controlling or interfacing with the underlying hardware. For instance, the drivers 722 can include display drivers, camera drivers, Bluetooth® or Bluetooth® Low Energy (BLE) drivers, flash memory drivers, serial communication drivers (e.g., Universal Serial Bus (USB) drivers), Wi-Fi® drivers, audio drivers, power management drivers, and so forth.

The libraries 710 provide a low-level common infrastructure used by the applications 706. The libraries 710 can include system libraries 718 (e.g., C standard library) that provide functions such as memory allocation functions, string manipulation functions, mathematic functions, and the like. In addition, the libraries 710 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., a WebKit® engine to provide web browsing functionality), and the like. The libraries 710 can also include a wide variety of other libraries 728 to provide many other APIs to the applications 706.

The frameworks 708 provide a high-level common infrastructure that is used by the applications 706. For example, the frameworks 708 provide various graphical user interface (GUI) functions, high-level resource management, and high-level location services. The frameworks 708 can provide a broad spectrum of other APIs that can be used by the applications 706, some of which may be specific to a particular operating system or platform.

In an example, the applications 706 may include a home application 736, a contacts application 730, a browser application 732, a book reader application 734, a location application 742, a media application 744, a messaging application 746, a game application 748, and a broad assortment of other applications such as a third-party application 740. The third-party applications 740 are programs that execute functions defined within the programs.

In a specific example, a third-party application 740 (e.g., an application developed using the Google Android or Apple iOS software development kit (SDK) by an entity other than the vendor of the particular platform) may be mobile software running on a mobile operating system such as Google Android, Apple iOS (for iPhone or iPad devices), Windows Mobile, Amazon Fire OS, RIM BlackBerry OS, or another mobile operating system. In this example, the third-party application 740 can invoke the API calls 750 provided by the operating system 712 to facilitate functionality described herein.

Various programming languages can be employed to create one or more of the applications 706, structured in a variety of manners, such as object-oriented programming languages (e.g., Objective-C, Java, C++, or R) or procedural programming languages (e.g., C or assembly language). For example, R is a programming language that is particularly well suited for statistical computing, data analysis, and graphics.

Any of the functionality described herein can be embodied in one or more computer software applications or sets of programming instructions. According to some examples, “function,” “functions,” “application,” “applications,” “instruction,” “instructions,” or “programming” are program(s) that execute functions defined in the programs. Various programming languages can be employed to develop one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may include mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer devices or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of evaluating field reports comprising:
storing, in a memory of one or more computing devices, a plurality of field reports, wherein each field report comprises a user identifier, a submission timestamp, a place identifier, and at least one user-submitted label representing a place attribute;
storing in the memory a plurality of user records, wherein each user record comprises the user identifier and a global user credibility score;
retrieving from the memory a subset of the stored field reports according to an evaluation time period;
identifying one or more distinct place identifiers in the subset, wherein each identified distinct place identifier is associated with a set of place attributes;
establishing one or more place-attribute pairs, each comprising one of the distinct place identifiers and its associated set of place attributes;
generating a set of tentatively accepted labels, each associated with one of the user-submitted labels and its associated submission timestamp, from a first timestamp to a reference timestamp, wherein each tentatively accepted label is based on the global user credibility score, a decay factor, and a cumulative candidate label score; and
repeating the generating process iteratively, by submission timestamp, until the reference timestamp equals a last timestamp.

2. The method of claim 1, wherein the process of generating a set of tentatively accepted labels further comprises:
producing a first set of tentatively accepted labels associated with a first distinct place identifier, iteratively, by place attribute, for each place attribute in the associated set of place attributes;
producing a subsequent set of tentatively accepted labels associated with a subsequent distinct place identifier, iteratively, by place identifier, for each distinct place identifier in the subset; and
defining a current superset of tentatively accepted labels associated with a current iteration, the current superset comprising the first set and the subsequent set.

3. The method of claim 3, further comprising:
determining whether a label condition is satisfied based on a comparison of each set of tentatively accepted labels in the current superset, by place-attribute pair, with each set of tentatively accepted labels in at least one preceding superset; and
in response to determining that the label condition is satisfied, selecting an accepted label for each place attribute in the subset, wherein each accepted label comprises a most recent value from the current superset.

4. The method of claim 3, further comprising:
in response to determining that the label condition is not satisfied, updating the global user credibility score associated with each user identifier based on an evaluation of each and every user-submitted label in the subset as of its associated submission timestamp; and
repeating the generating process, iteratively and in accordance with the updated global user credibility score, to produce a next superset of tentatively accepted labels associated with a next iteration, until the label condition is satisfied.

5. The method of claim 1, wherein the process of generating a set of tentatively accepted labels further comprises, for each user-submitted label:
calculating the decay factor (d) based on a relative age (A) of each user-submitted label at its submission timestamp relative to the reference timestamp and a parameter (Tau) related to the associated place attribute, according to the equation:
$$d = exp ( \frac{A}{Tau} )$$
calculating a decay-adjusted attribute-level user credibility score based on the global user credibility score and the calculated decay factor for each user-submitted label in the subset;
identifying one or more distinct candidate labels from among the user-submitted labels in the subset; and
calculating the cumulative candidate label score associated with each of the identified distinct candidate labels.

6. The method of claim 4, wherein the step of updating the global user credibility score associated with each user identifier comprises:
generating the evaluation based on whether the user-submitted label matches the accepted label selected as of the submission timestamp, wherein the evaluation is a binary variable comprising one for a match and zero otherwise; and
calculating the updated global user credibility score based on a summation of the evaluations for all user-submitted labels in the subset divided by the total number of user-submitted labels in the sub set.

7. The method of claim 1, further comprising:
identifying one or more static place attributes among the associated set of place attributes; and
setting the decay factor to one for each identified static place attribute.

8. A system for validating field reports, comprising:
a memory that stores instructions; and
a processor configured by the stored instructions to perform operations comprising the steps of:
storing in the memory a plurality of field reports, wherein each field report comprises a user identifier, a submission timestamp, a place identifier, and at least one user-submitted label representing a place attribute;
storing in the memory a plurality of user records, wherein each user record comprises the user identifier and a global user credibility score;
retrieving from the memory a subset of the stored field reports according to an evaluation time period;
identifying one or more distinct place identifiers in the subset, wherein each identified distinct place identifier is associated with a set of place attributes;
establishing one or more place-attribute pairs, each comprising one of the distinct place identifiers and its associated set of place attributes;
generating a set of tentatively accepted labels, each associated with one of the user-submitted labels and its associated submission timestamp, from a first timestamp to a reference timestamp, wherein each tentatively accepted label is based on the global user credibility score, a decay factor, and a cumulative candidate label score; and
repeating the generating process iteratively, by submission timestamp, until the reference timestamp equals a last timestamp.

9. The system of claim 8, wherein the step of generating a set of tentatively accepted labels further comprises:
producing a first set of tentatively accepted labels associated with a first distinct place identifier, iteratively, by place attribute, for each place attribute in the associated set of place attributes;
producing a subsequent set of tentatively accepted labels associated with a subsequent distinct place identifier, iteratively, by place identifier, for each distinct place identifier in the subset; and
defining a current superset of tentatively accepted labels associated with a current iteration, the current superset comprising the first set and the subsequent set.

10. The system of claim 9, wherein the processor is configured by the stored instructions to perform further operations comprising:
determining whether a label condition is satisfied based on a comparison of each set of tentatively accepted labels in the current superset, by place-attribute pair, with each set of tentatively accepted labels in at least one preceding superset; and
in response to determining that the label condition is satisfied, selecting an accepted label for each place attribute in the subset, wherein each accepted label comprises a most recent value from the current superset.

11. The system of claim 10, wherein the processor is configured by the stored instructions to perform further operations comprising:
in response to determining that the label condition is not satisfied, updating the global user credibility score associated with each user identifier based on an evaluation of each and every user-submitted label in the subset as of its associated submission timestamp; and
repeating the generating process, iteratively and in accordance with the updated global user credibility score, to produce a next superset of tentatively accepted labels associated with a next iteration, until the label condition is satisfied.

12. The system of claim 8, wherein the step of generating a set of tentatively accepted labels further comprises, for each user-submitted label:
calculating the decay factor (d) based on a relative age (A) of each user-submitted label at its submission timestamp relative to the reference timestamp and a parameter (Tau) related to the associated place attribute, according to the equation:
$$d = exp ( \frac{A}{Tau} )$$
calculating a decay-adjusted attribute-level user credibility score based on the global user credibility score and the calculated decay factor for each user-submitted label in the subset;
identifying one or more distinct candidate labels from among the user-submitted labels in the subset; and
calculating the cumulative candidate label score associated with each of the identified distinct candidate labels.

13. The system of claim 11, wherein the step of updating the global user credibility score associated with each user identifier comprises:
generating the evaluation based on whether the user-submitted label matches the accepted label selected as of the submission timestamp, wherein the evaluation is a binary variable comprising one for a match and zero otherwise; and
calculating the updated global user credibility score based on a summation of the evaluations for all user-submitted labels in the subset divided by the total number of user-submitted labels in the sub set.

14. The system of claim 8, wherein the processor is configured by the stored instructions to perform further operations comprising:
identifying one or more static place attributes among the associated set of place attributes; and
setting the decay factor to one for each identified static place attribute.

15. A non-transitory computer-readable medium storing program code which, when executed, is operative to cause an electronic processor to perform the steps of:
storing in the memory a plurality of field reports, wherein each field report comprises a user identifier, a submission timestamp, a place identifier, and at least one user-submitted label representing a place attribute;
storing in the memory a plurality of user records, wherein each user record comprises the user identifier and a global user credibility score;
retrieving from the memory a subset of the stored field reports according to an evaluation time period;
identifying one or more distinct place identifiers in the subset, wherein each identified distinct place identifier is associated with a set of place attributes;
establishing one or more place-attribute pairs, each comprising one of the distinct place identifiers and its associated set of place attributes;
generating a set of tentatively accepted labels, each associated with one of the user-submitted labels and its associated submission timestamp, from a first timestamp to a reference timestamp, wherein each tentatively accepted label is based on the global user credibility score, a decay factor, and a cumulative candidate label score; and
repeating the generating process iteratively, by submission timestamp, until the reference timestamp equals a last timestamp.

16. The non-transitory computer-readable medium of claim 15, wherein the step of generating a set of tentatively accepted labels further comprises:
producing a first set of tentatively accepted labels associated with a first distinct place identifier, iteratively, by place attribute, for each place attribute in the associated set of place attributes;
producing a subsequent set of tentatively accepted labels associated with a subsequent distinct place identifier, iteratively, by place identifier, for each distinct place identifier in the subset; and
defining a current superset of tentatively accepted labels associated with a current iteration, the current superset comprising the first set and the subsequent set.

17. The non-transitory computer-readable medium of claim 16, wherein the stored program code which, when executed, is operative to cause an electronic processor to perform the further steps of:
determining whether a label condition is satisfied based on a comparison of each set of tentatively accepted labels in the current superset, by place-attribute pair, with each set of tentatively accepted labels in at least one preceding superset; and
in response to determining that the label condition is satisfied, selecting an accepted label for each place attribute in the subset, wherein each accepted label comprises a most recent value from the current superset.

18. The non-transitory computer-readable medium of claim 17, wherein the stored program code which, when executed, is operative to cause an electronic processor to perform the further steps of:
in response to determining that the label condition is not satisfied, updating the global user credibility score associated with each user identifier based on an evaluation of each and every user-submitted label in the subset as of its associated submission timestamp; and
repeating the generating process, iteratively and in accordance with the updated global user credibility score, to produce a next superset of tentatively accepted labels associated with a next iteration, until the label condition is satisfied.

19. The non-transitory computer-readable medium of claim 15, wherein the step of generating a set of tentatively accepted labels further comprises, for each user-submitted label:
calculating the decay factor (d) based on a relative age (A) of each user-submitted label at its submission timestamp relative to the reference timestamp and a parameter (Tau) related to the associated place attribute, according to the equation:
$$d = exp ( \frac{A}{Tau} )$$
calculating a decay-adjusted attribute-level user credibility score based on the global user credibility score and the calculated decay factor for each user-submitted label in the subset;
identifying one or more distinct candidate labels from among the user-submitted labels in the subset; and
calculating the cumulative candidate label score associated with each of the identified distinct candidate labels.

20. The non-transitory computer-readable medium of claim 18, wherein the step of updating the global user credibility score associated with each user identifier comprises:
generating the evaluation based on whether the user-submitted label matches the accepted label selected as of the submission timestamp, wherein the evaluation is a binary variable comprising one for a match and zero otherwise; and
calculating the updated global user credibility score based on a summation of the evaluations for all user-submitted labels in the subset divided by the total number of user-submitted labels in the sub set.
